(19) United States
(12) Patent Application Publication
(10) Pub. No.: US 2015/0275904 A1
(43) Pub. Date: Oct. 1, 2015

(54) MOTOR AND FAN INCLUDING THE MOTOR

(71) Applicant: Nidec Corporation, Kyoto (JP)

(72) Inventor: Zhaowu GU, Dalian City (CN)

(21) Appl. No.: 14/642,959

(22) Filed: Mar. 10, 2015

(30) Foreign Application Priority Data
Mar. 28, 2014 (CN) 201410123875.0
Mar. 28, 2014 (CN) 201420149877.2

(51) Int. Cl. F04D 25/06; F04D 19/00; H02K 11/00

(52) U.S. Cl. CPC F04D 25/06; H02K 11/00; F04D 19/002

(57) ABSTRACT

A motor includes a stationary portion and a rotary portion. The stationary portion includes an armature, a circuit board, and a base portion. The base portion includes a bearing holder, a central tower portion configured to support the bearing holder and a wall portion which surrounds the circuit board at a radial outer side such that a radial gap is defined between the circuit board and the wall portion. The circuit board includes a through-hole defined at a center thereof, and the central tower portion supports a periphery of the through-hole. Filler material is filled at upper and lower sides of the circuit board, and the circuit board includes at least one exhaust hole. The radial gap and the at least one exhaust hole communicate with each other through an axial space between a lower surface of the circuit board and an upper surface of the base portion.

### BACKGROUND OF THE INVENTION

1. Field of the Invention

The present invention relates to a motor and a fan including the motor.

2. Description of the Related Art

A motor is used in many different environments. In the related art, it is known that dust proofing and water proofing of a motor can be realized by protecting a coil or a circuit board of the motor for the purpose of ensuring the operation of the motor even in harsh environments. For example, Japanese Patent No. 3432380 discloses that water proofing of a fan motor is realized by protecting a stator through the injection of a silicon resin. As shown in FIG. 1, a silicon resin 25 is injected into a mold space from a silicon resin injection port 30, thereby covering a circuit board 4 with the silicon resin and providing a water proofing effect. However, in the case of injecting filler, the fluidity of the filler is poor and it takes time to fill the filler since there is no exhaust hole for discharging air therethrough. Further, it is highly likely that the air remaining at the upper and the lower sides of the circuit board becomes air bubbles. If the bubbles are generated in the filling process, the water proofing effect of the motor is reduced.

### SUMMARY OF THE INVENTION

Preferred embodiments of the present invention provide a motor having superior waterproof performance.

In accordance with a preferred embodiment of the present invention, a motor includes a stationary portion; and a rotary portion having a center axis, wherein the rotary portion is rotatably supported with respect to the stationary portion so as to rotate about the center axis. The stationary portion includes an armature, a circuit board disposed below the armature, and a base portion configured to support the armature and the circuit board. The base portion includes a bearing holder, a central tower portion configured to support the bearing holder, and a wall portion which surrounds the circuit board at a radial outer side such that a radial gap is defined between the circuit board and the wall portion. The circuit board includes a through-hole defined at a center thereof, and the central tower portion is configured to support a periphery of the through-hole. Filler is filled at an upper and a lower side of the circuit board and the circuit board includes at least one exhaust hole. The radial gap and the at least one exhaust hole communicate with each other through an axial space between a lower surface of the circuit board and an upper surface of the base portion.

By providing at least one exhaust hole in the circuit board, air is discharged during the filling process of the filler. Thus, the possibility of generation of air bubbles is reduced and electronic components of the circuit board are further reliably protected. This makes it possible to enhance a waterproof performance of the motor.

The fan provided with the motor includes an impeller, which rotate together with the rotary portion of the motor. Since the fan is provided with the motor having high waterproof performance, it is possible to improve the waterproof performance of the fan.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a sectional view of a conventional fan motor.

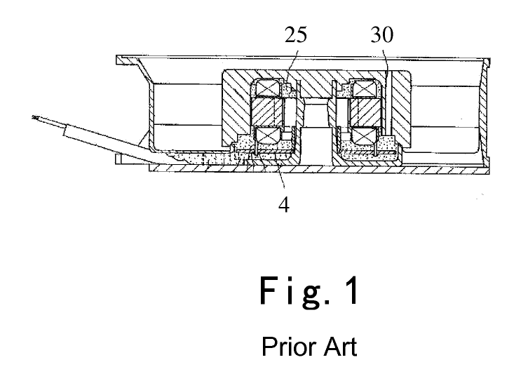

FIG. 2 is a partial sectional view a fan according to a preferred embodiment of the present invention.

FIG. 3 is a top view of a circuit board of the fan according to a preferred embodiment of the present invention.

### DETAILED DESCRIPTION OF THE PREFERRED EMBODIMENTS

A fan according to preferred embodiments of the present invention will now be described in detail with reference to the accompanying drawings. The preferred embodiments and the drawings are described below as examples and are not intended to limit the scope of the present invention. If necessary, the features of preferred embodiments of the present invention may be appropriately combined.

In the following description, the direction extending along a center axis O-O′ of a rotary portion of a motor will be referred to as “axial”. The direction orthogonal or substantially orthogonal to the center axis O-O′ of the rotary portion will be referred to as “radial”. The side of a rotor holder in the axial direction will be referred to as “upper”. The side of a circuit board in the axial direction will be referred to as “lower”. The direction going away from the center axis O-O′ in the radial direction will be referred to as “outer”. The direction coming toward the center axis O-O′ in the radial direction will be referred to as “inner”. However, the upper, lower, inner and outer directions are defined merely for the sake of description and are not intended to limit the in-use directions of a motor and a fan.

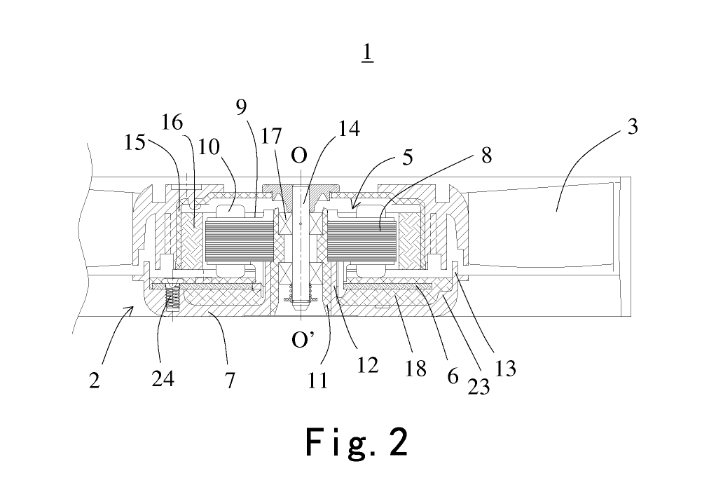

FIG. 2 is a sectional view of a fan 1 according to a preferred embodiment of the present invention. The fan 1 preferably includes a motor 2 and an impeller 3. The motor preferably includes a stationary portion and a rotary portion having a center axis O-O′. The rotary portion is rotatably supported with respect to the stationary portion so as to rotate about the center axis O-O′ of the rotary portion. The stationary portion preferably includes an armature 5, a circuit board 6 arranged below the armature 5, and a base portion 7 configured to support the armature 5 and the circuit board 6. The armature 5 preferably includes an iron core 8 and a coil 10 wound around the iron core 8 with an insulator 9 interposed therebetween. Electronic components are arranged on the circuit board 6 and lead wires configured to supply electric power therethrough are connected to the coil 10 to control the motor. The base portion preferably includes a bearing holder 11, a central tower portion 12, and a wall portion 13. The central tower portion 12 supports the bearing holder 11. The wall portion 13 surrounds the circuit board 6 at the radial outer side.

The rotary portion preferably includes a shaft 14, a rotor holder 15, and a rotor magnet 16 attached to the inner surface of the rotor holder 15. The shaft 14 is arranged in a coaxial relationship with the center axis O-O′ and is rotatably supported by a bearing 17 arranged in the bearing holder 11. The rotor holder 15 is directly or indirectly fixed to the shaft 14. Therefore, the rotor holder 15 rotates together with the shaft 14. The rotor magnet 16 is radially opposite to the armature 5. The impeller 3 is connected to the rotor holder 15 and is rotated together with the rotary portion of the motor 2. The motor 2 preferably further includes filler material 18 which is filled at the upper and the lower sides of the circuit board 6.

Preferably, the filler material 18 is preferably composed of, for example, one or more of an epoxy resin, a silicon rubber and a polyurethane resin. These materials are superior in electrical insulation and waterproof characteristics.

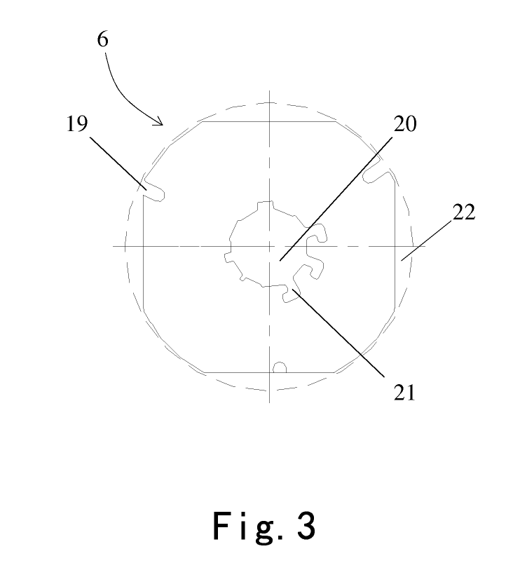

FIG. 3 is a top view of the circuit board of the motor of the fan according to a preferred embodiment of the present invention. The circuit board 6 is indicated by a solid line. The inner circumferential surface of the wall portion 13 of the base portion 7 is indicated by a dot line. As shown in FIG. 3, a radial gap 19 is defined between the circuit board 6 and the wall portion 13. This makes it easy to fill the filler material 18. The periphery of a through-hole 20 defined at the center of the circuit board 6 is supported on the central tower portion 12 of the base portion 7. Preferably, the central tower portion 12 of the base portion 7 includes a taper portion. The circuit board 6 is fixed to the taper portion by mounting the periphery of the through-hole 20 on the taper portion. Thus, the fixing of the circuit board 6 is realized. The circuit board 6 preferably includes at least one exhaust hole 21 arranged at or near the through-hole 20. The radial gap 19 and the exhaust hole 21 communicate with each other through an axial space between the lower surface of the circuit board 6 and the upper surface of the base portion 7. Since at least the exhaust hole 21 defining and serving as an exhaust port is provided in the circuit board 6, air existing between the circuit board 6 and the base portion is reliably discharged during the filling process of the filler material 18. Thus, the possibility of generation of air bubbles is significantly reduced or prevented, which makes it possible to enhance the waterproof characteristics. Accordingly, it is possible to reliably protect the electronic components arranged on the circuit board 6 and the waterproof performance of the motor is further improved. In the illustrated example, the exhaust hole 21 and the through-hole 20 preferably communicate with each other. However, the exhaust hole 21 may be arranged around the through-hole 20 without communicating with the through-hole 20.

Outer cutouts 22 preferably are provided in the circuit board 6. In this case, the outer cutouts 22 are preferably located in the outer peripheral edge of the circuit board 6. This helps widen a space used for the injection of the filler material 18, thus improving the fluidity of the filler material 18. In the preferred embodiment shown in FIG. 3, the number of the outer cutouts 22 is preferably four, for example. Thus, the circuit board 6 preferably has a square or substantially square shape, for example. The number of the outer cutouts 22 may be arbitrarily changed without departing from the scope of the common knowledge of a person skilled in the art. Therefore, the circuit board may have a polygonal shape, for example. This makes it possible to increase the dimension of the injection port used for the filler material and to secure the exhaust port, eventually improving the fluidity of the filler material. In another preferred embodiment of the present invention, the respective exhaust holes 21 may radially correspond to the outer cutouts 22. This makes it possible to improve the fluidity of the filler in the filling process of the filler. In further another preferred embodiment of the present invention, at least one of the outer cutouts 22 may define and serve as an outlet of the lead wires of the circuit board 6. With this structure, it becomes easy to draw out the lead wires.

Referring again to FIG. 2, the base portion 7 preferably includes a step portion 23 which extends radially inward from the inner circumferential side of the wall portion of the base portion 7. The step portion 23 supports the circuit board 6. The circuit board 6 may be fixed to the step portion 23 by, for example, a screw 24 or the like. By virtue of the step portion 23 on which the circuit board 6 is mounted, the fixing of the circuit board 6 is more reliably realized. In order not to hinder the communication between the radial gap 19 and the exhaust hole 21, it is preferred that the step portion is not extended over the entire circumference but is divisionally disposed in three or more sections.

While the present invention has been described with respect to preferred embodiments of fan motors as examples, the above-described structure may be applied to other motor structures.

Preferred embodiments of the present invention additionally have the following advantages.

The central tower portion includes the taper portion. Since the taper portion receives the periphery of the through-hole of the circuit board, the circuit board is fixed without being radially deviated.

The step portion extending radially inward from the inner circumferential surface of the wall portion of the base portion is provided to support the circuit board. By virtue of the step portion, the circuit board is fixed even at the radial outer portion. Thus, the fixing of the circuit board becomes stable. In addition, the step portion and the circuit board is fixed to each other by the screw or the like.

Since the exhaust hole and the through-hole communicate with each other, air is discharged through the exhaust hole during the filling process of the filler. This provides an effect of preventing generation of air bubbles.

The circuit board includes the outer cutouts provided in the outer peripheral edge of the circuit board. This helps widen the injection space of the filler. It is therefore possible to accelerate the discharge of air and to improve the fluidity of the filler. By accelerating the discharge of air, there is provided an effect of preventing generation of air bubbles.

The exhaust holes are provided to radially correspond to the outer cutouts. This makes it possible to improve the fluidity of the filler in the filling process.

In one preferred embodiment of the present invention, at least one of the outer cutouts defines and serves as the outlet of the lead wires connected at one ends to the circuit board. This makes it easy to draw out the lead wires.

In another preferred embodiment of the present invention, the circuit board preferably has a polygonal shape, for example. This makes it possible to increase the dimension of the injection port to fill the filler and to improve the fluidity of the filler.

In a further preferred embodiment of the present invention, the filler is preferably composed of one or more of an epoxy resin, a silicon rubber and a polyurethane resin, for example. These materials are superior in insulation and waterproof characteristics.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A motor comprising:
a stationary portion; and
a rotary portion including a center axis, wherein
the rotary portion is rotatably supported with respect to the stationary portion so as to rotate about the center axis;
the stationary portion includes an armature, a circuit board disposed below the armature, and a base portion configured to support the armature and the circuit board;
the base portion includes a bearing holder, a central tower portion configured to support the bearing holder, and a wall portion which surrounds the circuit board at a radial outer side such that a radial gap is defined between the circuit board and the wall portion;
the circuit board includes a through-hole defined at a center thereof, and the central tower portion is configured to support a periphery of the through-hole;
filler material is filled at an upper and a lower side of the circuit board; and
the circuit board includes at least one exhaust hole, and the radial gap and the at least one exhaust hole communicate with each other through an axial space between a lower surface of the circuit board and an upper surface of the base portion.

2. The motor of claim 1, wherein the central tower portion includes a taper portion, and the periphery of the through-hole is supported by and fixed to the taper portion.

3. The motor of claim 1, wherein the base portion further includes a step portion extending radially inward from an inner circumferential surface of the wall portion of the base portion, and the circuit board is fixed to the step portion.

4. The motor of claim 2, wherein the at least one exhaust hole and the through-hole communicate with each other.

5. The motor of claim 3, wherein the circuit board further includes one or more outer cutouts located in an outer peripheral edge of the circuit board.

6. The motor of claim 5, wherein the at least one exhaust hole radially corresponds to the one or more outer cutouts.

7. The motor of claim 5, wherein at least one of the one or more outer cutouts defines an outlet of lead wires connected to the circuit board.

8. The motor of claim 1, wherein the circuit board has a polygonal shape.

9. The motor of claim 1, wherein the filler material is selected from a group consisting of an epoxy resin, a silicon rubber, and a polyurethane resin.

10. A fan comprising:
the motor of claim 1; and
an impeller configured to rotate together with the rotary portion of the motor.
